(19) United States
(12) Patent Application Publication
(10) Pub. No.: US 2022/0416349 A1
(43) Pub. Date: Dec. 29, 2022

(54) BATTERY RECEPTACLE FOR A RAIL VEHICLE

(71) Applicant: Siemens Mobility GmbH, Muenchen (DE)

(72) Inventor: Stefan Hintermeir, Aschau I. Ch (DE)

(21) Appl. No.: 17/778,881

(22) PCT Filed: Nov. 10, 2020
(86) PCT No.: PCT/EP2020/081574

§ 371 Date: May 23, 2022

(30) Foreign Application Priority Data
Nov. 21, 2019 (DE) 10 2019 217 975.4

(51) Int. Cl. H01M 50/249; B60R 16/04; H01M 50/258; H01M 50/244

(52) U.S. Cl. CPC H01M 50/249; B60R 16/04; H01M 50/258; H01M 50/244; H01M 2220/20

(57) ABSTRACT

A battery receptacle for a rail vehicle and a rail vehicle with a battery receptacle. The battery receptacle has a volume form which deviates from a cuboidal form. The battery receptacle has connection elements that are designed such that the battery receptacle can be pivotally connected to an associated battery box of the rail vehicle so that when the battery receptacle is rotated about an axis it can be rotated into the battery box or rotated out of the battery box.

The invention relates to a battery receptacle for a rail vehicle and to a rail vehicle comprising a battery receptacle.

Rail vehicles are equipped with an on-board electrical system which, in the event of failure of a primary energy source, is also intended to be fed by batteries of any design.

In rail vehicles, these batteries are stowed either underfloor or in the rail vehicle. The stowage spaces for the batteries are called battery boxes.

The batteries of rail vehicles normally comprise a plurality of battery cells, which are arranged in a battery receptacle and are connected or wired to one another there. Usually, the battery cells are connected in series, the battery cells usually having the same design and the same electrical power.

The battery cells of the battery receptacle are usually cabled to one another on their top side. The total voltage of a battery receptacle generally results from the sum of the battery cells multiplied by the voltage of an individual battery cell.

Batteries of rail vehicles must be maintained. This assumes good accessibility to the battery receptacles and also to the battery cells. The prior art is, therefore, for the associated battery boxes to be arranged at an easily accessible rail vehicle location.

For example, the underfloor area of the rail vehicle, in which the battery boxes are mounted on the rail vehicle, is considered here.

Such a battery box is, for example, equipped with telescopic rails, by using which a battery receptacle arranged in the battery box can be moved translationally out of the battery box in a straight line.

In the extended position of the battery receptacle, maintenance work is carried out on the battery cells—for example the battery acid is topped up in this position.

The effect of the fact that the battery cells in a battery receptacle are moved translationally in and out of the battery box in a straight line is that the battery boxes have a cuboidal shape and outline.

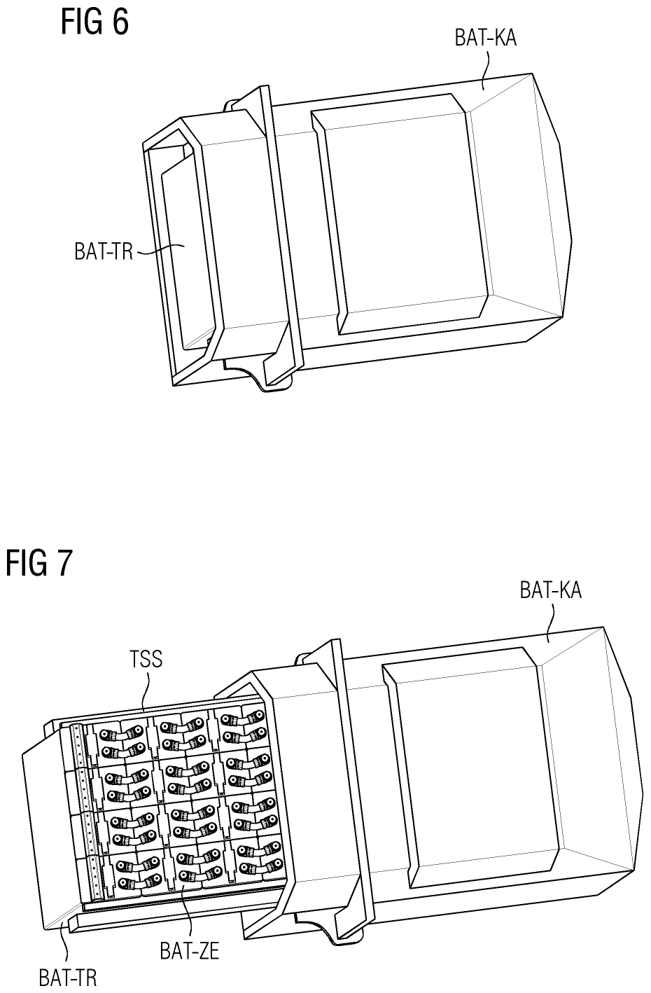

FIG. 6 and FIG. 7 show this relationship in two positions of a battery receptacle BAT-TR in relation to the associated battery box BAT-KA.

FIG. 6 shows the battery receptacle BAT-TR which has been retracted completely into the associated battery box BAT-KA.

FIG. 7 shows the battery receptacle BAT-TR which has been moved out of the associated battery box BAT-KA.

In order to move the battery receptacle BAT-TR out, telescopic rails TSS which connect the battery receptacle BAT-TR to the battery box BAT-KA are provided. By using the telescopic rails TSS, the above-described translational movement of the battery receptacle BAT-TR in relation to the battery box BAT-KA is made possible. The use of telescopic rails dictates a cuboidal geometry of the battery box.

The battery receptacle BAT-TR includes a number of battery cells BAT-ZE, which are connected electrically to one another on their top side.

Battery cells for rail vehicles are very heavy, so that the mounting of a battery receptacle filled with battery cells must be done with lifting equipment.

Accordingly, battery receptacles with a cuboidal shape, which are provided for corresponding cuboidal battery boxes, are equipped with receptacles for fork tines or forklift tines or other lifting equipment. The mounting of the battery receptacles is then carried out with the aid of a forklift truck or with the aid of similar equipment.

In summary, the cuboidal shape of battery boxes and battery receptacle in conjunction with the tine-shaped receptacle on the battery receptacle permits easier mounting and dismounting.

The disadvantage is that there is a restriction to this actual design or shape when designing rail vehicles.

The object of the present invention is, therefore, to configure a battery receptacle with associated battery box in such a way that the aforementioned restriction is overcome and, at the same time, simple maintenance of the battery cells of the battery receptacle is made possible.

This object is achieved by the features of claim 1 and of claim 8.

Advantageous developments are specified in the respective dependent claims.

The invention relates to a battery receptacle for a rail vehicle. The battery receptacle has a volume shape which differs from a cuboidal shape. The battery receptacle has connecting means which are formed in such a way that the battery receptacle can be connected rotatably to an associated battery box of the rail vehicle, so that, by means of a rotation carried out about an axis, the battery receptacle can be swiveled into the battery box and swiveled out of the battery box.

In a preferred embodiment, the battery receptacle has a volume which is determined by a base surface and by associated side surfaces, wherein the base surface is similar to a triangle or is a triangle or is similar to a trapezium or is a trapezium, and wherein the associated side surfaces are substantially perpendicular to the base surface.

In a preferred embodiment, the battery receptacle contains battery cells which are arranged in the battery receptacle so as to be connected electrically to one another.

In a preferred embodiment, the battery receptacle has a lifting assembly, which is designed for a vertical movement of the battery receptacle and is connected to the latter, wherein the lifting assembly is designed to move the battery receptacle together with the battery cells located therein by means of lifting equipment.

In a preferred embodiment, the lifting assembly has a crane eye which is designed to move the battery receptacle together with the battery cells located therein by means of lifting equipment.

In a preferred embodiment, the crane eye is arranged vertically above the center of gravity of the battery receptacle or above the center of gravity of the battery receptacle filled with battery cells.

In a preferred embodiment, the battery receptacle has a hinge half as a connecting means.

In a preferred embodiment, a rail vehicle has a battery receptacle as described above and a battery box. The battery receptacle is rotatably connectable via connecting means to the battery box of the rail vehicle in such a way that, by means of a rotation carried out about an axis, the battery receptacle can be swiveled into the battery box and swiveled out of the battery box.

In a preferred embodiment, the connecting means comprise the following elements:
a hinge half, which is connected to the battery receptacle,
a hinge pin and a hinge pin holder, wherein the hinge pin is connected to the battery box via the hinge pin holder.

The hinge half engages in the hinge pin when mounted, wherein the hinge half is connected to a loose hinge half after it has been engaged in the hinge pin.

In a preferred embodiment, the shape of the battery box is similar to or identical to the shape of the battery receptacle, so that the battery receptacle is accommodated completely by the battery box without leaving any volume unused.

The invention makes it possible for battery cells, the shape of which is no longer restricted to the previously usual battery receptacle shape, to be arranged in battery receptacles.

Therefore, existing previously unused volumes of any desired shape in the rail vehicle can be made usable to receive battery boxes.

Despite the high weight of the assembly comprising “battery receptacle with battery cells”, the invention makes it possible for these to be mounted with the aid of lifting equipment.

The invention makes it possible for maintenance work on the battery receptacle or on the battery cells arranged therein to be carried out with little effort.

In particular, no heavy device (for example an industrial truck or forklift truck) is needed to swivel the battery receptacle out.

The invention permits free and simple access to the battery cells of the battery receptacle.

The invention permits a compact design of the battery receptacles and the battery receptacle modules.

The invention permits integration of a plurality of battery receptacles in a battery box. The battery receptacles are preferably arranged vertically above one another in the battery box.

The present invention will be explained in more detail below by way of example with reference to a drawing, in which:

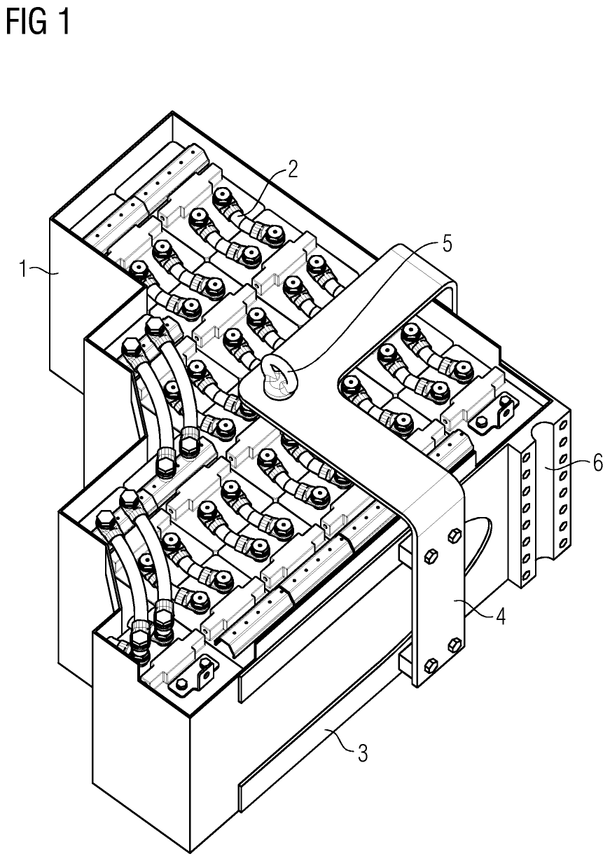

FIG. 1 shows an exemplary embodiment of a battery receptacle according to the invention,

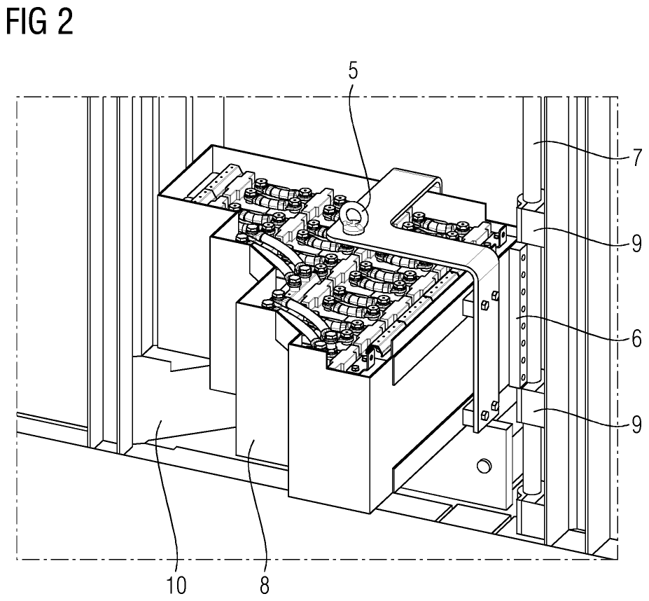

FIG. 2 shows, with reference to FIG. 1, positioning of the battery receptacle in a battery box of a rail vehicle,

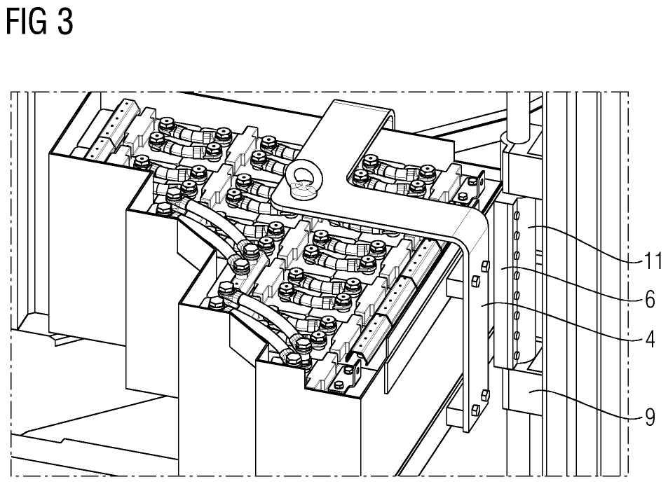

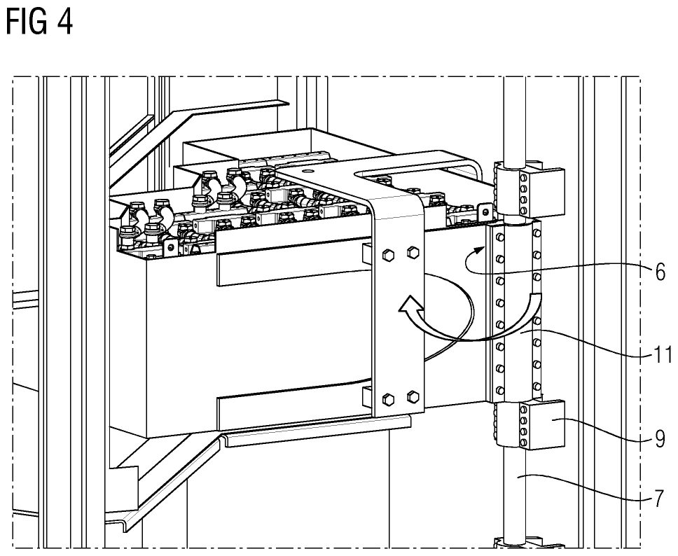

FIG. 3 and FIG. 4 show, with reference to FIG. 1 and FIG. 2, details of a screw fixing of a battery receptacle in the battery box,

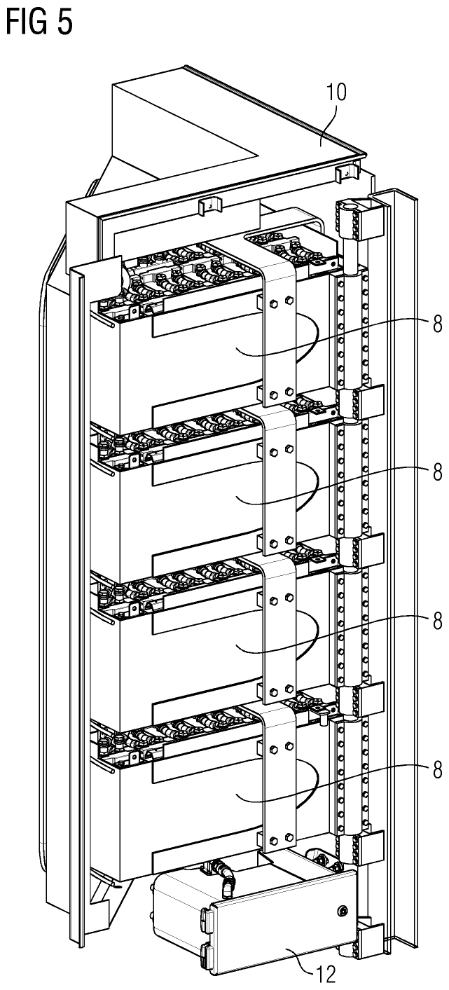

FIG. 5 shows, with reference to FIG. 1 to FIG. 4, a completely populated battery box,

FIG. 6 and FIG. 7 show the battery receptacle described in the introduction with associated battery box from the prior art.

FIG. 1 shows an exemplary embodiment of a battery receptacle 1 according to the invention.

The battery receptacle 1 has a triangle-shaped base surface, which is continued upward uniformly in the vertical direction.

The battery receptacle 1 includes a number of battery cells 2 which are wired to one another and which preferably have the same design.

The battery receptacle 1 is preferably fabricated from steel for stability reasons.

The battery receptacle 1 also has reinforcements 3, a lifting assembly 4, a crane eye 5 and a hinge half 6, the function of which will be described below.

By using the lifting assembly 4 and by using the crane eye 5, the battery receptacle 1 together with the pre-mounted battery cells 2 can be moved with lifting equipment.

The crane eye is preferably arranged above the center of gravity of the battery receptacle 1 filled with battery cells 2 in order to simplify its movement during mounting, dismounting and when carrying out maintenance work on the battery cells.

FIG. 2 shows, with reference to FIG. 1, positioning of the battery receptacle 1 in a battery box 10 of a rail vehicle.

The hinge half 6 of the battery receptacle 1 engages in a hinge pin 7 when mounted. The hinge pin 7—as described below—is connected to the battery box 10 with the participation of a hinge pin holder 9.

A so-called battery receptacle module 8, which will be described in more detail below, is formed at least from the battery receptacle 1, the battery cells 2, the hinge half 6 and the reinforcements 3.

The battery receptacle module 8 can additionally also comprise the lifting assembly 4 and the crane eye 5—but these can also optionally be designed to be separable or divisible from the battery receptacle module 8.

The battery receptacle module 8 is positioned on the hinge pin 7 with the aid of the hinge half 6. The connection is produced by screwing on a loose hinge half described below (in this regard, see the loose hinge half 11 in FIG. 3).

Via the hinge half 6, the hinge pin 7, the hinge pin holder 9 and via the loose hinge half (in this regard, see the loose hinge half 11 in FIG. 3), the battery receptacle 1 is rotatably connected to the battery box 10. Therefore, the battery receptacle 1 can be swiveled into the battery box 10 and the battery receptacle 1 can be swiveled out of the battery box 10.

The above-described reinforcements 3 are configured in such a way that forces both from the interacting hinge half 6, 7 and from the lifting assembly 4 can be transferred into the battery receptacle 1 in a stress-optimized manner.

The battery receptacle 1 comprising the elements described in FIG. 1 is lifted at the crane eye 5 by lifting equipment and mounted in the battery box 10.

The battery receptacle 1 is preferably fabricated from steel for stability reasons.

FIG. 3 and FIG. 4 show, with reference to FIG. 1 and FIG. 2, details of a screw fixing of a battery receptacle module 8 in the battery box 10.

On the rail vehicle there are the following assemblies: the hinge pin 7 with hinge pin holders 9, and the battery box 10, which protects the battery receptacle 8 from external influences in the finally mounted state and in the operating state of the rail vehicle.

The battery receptacle module 8 is conceived in such a way that the battery receptacle module 8 hanging on the crane eye 5 can be moved close to the battery box 10 in such a way that the hinge half 6 engages in the hinge pin 7 located in the vehicle.

The hinge pin 7 can be connected permanently to the rail vehicle or, as in this example, designed to be dismountable and mountable.

A hinge pin 7 designed to be dismountable and mountable has the advantage that additional bearing elements (not illustrated here) can be used for the simpler swiveling of the battery receptacle module 8.

Once the battery receptacle module 8 has been positioned such that the hinge half 6 engages in the hinge pin 7, then the hinge half 6 is connected to a loose hinge half 11—screwed in this example.

The connected hinge halves 6 and 11 form a hole in which the hinge pin 7 is located.

The battery receptacle module 8 is then swiveled about the hinge which is composed of the hinge halves 6, 11 and the hinge pin 7.

In order to make this swiveling possible, a clearance fit must be provided between the hinge pin 7 and the hole which is produced by the hinge halves 6 and 11.

In order to make the swiveling of the battery receptacle module 8 additionally easier, the “inner sides of the hole” of the hinge halves 6 and 11 are equipped with low-friction materials.

Once the two hinge halves 6 and 11 have been connected, the battery receptacle module 8 is lowered slowly. The battery receptacle module 8 slides downward on the hinge pin 7 until the two hinge halves 6 and 7 are resting on the lower of the two hinge pin holders 9.

The lower of the two hinge pin holders 9 absorbs the whole weight of the battery receptacle module 8.

In order to make the swiveling of the battery receptacle module 8 about the hinge pin 7 even easier, a friction-reducing intermediate layer (not illustrated here) can be introduced between the hinge halves 6 and 11 and the lower hinge pin holder 9.

Likewise, a bearing (not illustrated here) could be used at this point.

Likewise, the contact surfaces between the hinge halves 6 and 11 and the lower hinge pin holder 9 could be designed to have low friction. This is preferably implemented via coatings or inserts.

As soon as the battery receptacle module 8 is resting completely on the hinge pin holder 9, the lifting equipment is removed.

If necessary, the lifting assembly 4 together with the crane eye 5 can also be removed or they remain on the battery receptacle 1 for later use.

The battery receptacle module 8 is then swiveled into the battery box 10, fixed there and wired up—in this regard, see FIG. 5.

FIG. 5 shows, with reference to figures FIG. 1 to FIG. 4, a completely populated battery box 10, which contains a plurality of battery receptacle modules 8 arranged above one another.

After a first battery receptacle module 8 has been mounted, further battery receptacle modules 8 are installed and swiveled into the battery box 10 in the manner described above.

FIG. 5 shows a region 12 which is provided for fuses in the lower area of the battery box 10.

1-9. (canceled)

10. A battery receptacle assembly for a rail vehicle, the battery receptacle assembly comprising:
a battery assembly having a volume shape which differs from a cuboid shape;
a connector device configured to rotatably connect said battery receptacle to an associated battery box of the rail vehicle, for rotation about an axis enabling said battery receptacle to be selectively swiveled into the battery box and swiveled out of the battery box.

11. The battery receptacle assembly according to claim 10, wherein the volume shape is determined by a base surface and by associated side surfaces, wherein said base surface has a shape selected from the group consisting of generally triangular, triangular, generally trapeze-shaped, or trapezoid, and wherein said associated side surfaces are substantially perpendicular to said base surface.

12. The battery receptacle assembly according to claim 10, further comprising battery cells disposed in said battery receptacle and electrically connected to one another.

13. The battery receptacle assembly according to claim 12, further comprising a lifting assembly connected to said battery receptacle and configured for a vertical movement of said battery receptacle, wherein said lifting assembly is configured to move said battery receptacle together with said battery cells by way of lifting equipment.

14. The battery receptacle assembly according to claim 13, wherein said lifting assembly includes a crane eye configured to enable said battery receptacle to be moved together with said battery cells located therein by the lifting equipment.

15. The battery receptacle assembly according to claim 14, in which the crane eye is arranged vertically above a center of gravity of said battery receptacle filled with said battery cells.

16. The battery receptacle assembly according to claim 10, wherein said connector device comprises a half of a hinge.

17. A rail vehicle, comprising:
a battery receptacle according to claim 10; and
a battery box;
said battery receptacle being rotatably connected via the connector device to said battery box of the rail vehicle, wherein a rotation about an axis, allows said battery receptacle to be selectively swiveled into said battery box and swiveled out of said battery box.

18. The rail vehicle according to claim 17, wherein said connector device comprises:
a hinge half connected to said battery receptacle;
a hinge pin and a hinge pin holder connecting said hinge pin to said battery box;
said hinge half engaging said hinge pin when said battery receptacle is mounted to said battery box;
said hinge half being connected to a loose hinge half after an engagement of said hinge half in said hinge pin.
